(19) United States
(12) Patent Application Publication
(10) Pub. No.: US 2026/0029968 A1
(43) Pub. Date: Jan. 29, 2026

(54) STORAGE MEDIUM, PRINTING CONTENT EDITING APPARATUS, AND PRINTING CONTENT EDITING METHOD

(71) Applicant: CANON KABUSHIKI KAISHA, Tokyo (JP)

(72) Inventor: TAKAHIRO SAKAMOTO, Kanagawa (JP)

(21) Appl. No.: 19/269,606

(22) Filed: Jul. 15, 2025

(30) Foreign Application Priority Data
Jul. 29, 2024 (JP) 2024-122527

(51) Int. Cl. G06F 3/12

(52) U.S. Cl. CPC G06F 3/1208; G06F 3/1256; G06F 3/1287

(57) ABSTRACT

A computer functions as an editing unit that can edit a printing content including one or more objects in an editing region displaying a trim line corresponding to a cutting position of a printing medium; and a display control unit that displays a region related to the printing content on a display unit. In a case where setting of cutting the printing medium on which the printing content is printed at a position of the trim line is set, the display control unit displays a bleed line, which is different from the trim line and corresponds to a position to which printing processing is performed, the position being outside the cutting position, and a preview region displaying the printing content.

### BACKGROUND

### Field of the Invention

The present disclosure relates to a storage medium, a printing content editing apparatus, and a printing content editing method.

### Description of the Related Art

In recent years, a Web printing system that can produce and print a variety of printed products by utilizing a Web server and a computer and a printer disposed in a private home or a company has been provided. In the above-described Web printing system, printing is performed by downloading a printing job generated on the Web server to the computer via a printing application operating on the computer and transmitting the printing job from the computer to the printer by way of a printer driver.

In the Web application of the Web printing system, it is also possible to create a printing content on a premise that a printing paper (a printing medium) is cut after printing like a business card, for example. There is processing of designing (arranging) the printing content displayed on the Web application to reach a bleed line outside a trim line corresponding to a cutting position of the printing paper. With the above-described processing, even in a case where there is an error in the actual cutting position, an unintended blank space is unlikely to be generated between an edge (an end) of the printing paper after cutting and a colored portion of the printing content. Here, the above-described processing is referred to as bleed processing, and simply, this is extensional coloring of the printing content to reach the bleed line outside the trim line.

### SUMMARY

The present disclosure is directed to improve the convenience related to a bleed for a printing content.

In an aspect of the present disclosure, there is provided a non-transitory computer readable storage medium storing a program for causing a computer to perform as: an editing unit that can edit a printing content including one or more objects in an editing region displaying a trim line corresponding to a cutting position of a printing medium; and a display control unit that displays a region related to the printing content on a display unit, wherein in a case where setting of cutting the printing medium on which the printing content is printed at a position of the trim line is set, the display control unit displays a bleed line, which is different from the trim line and corresponds to a position to which printing processing is performed, the position being outside the cutting position, and a preview region displaying the printing content.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a configuration of a printing system;

FIG. 2 is a block diagram illustrating a hardware configuration of a terminal apparatus included in the printing system;

FIG. 3 is a block diagram illustrating a hardware configuration of a printing apparatus included in the printing system;

FIG. 4 is a block diagram illustrating a hardware configuration of a Web server included in the printing system;

FIG. 5A is a block diagram illustrating a software configuration of a computer as the terminal apparatus included in the printing system;

FIG. 5B is a block diagram illustrating a software configuration of a mobile terminal as the terminal apparatus included in the printing system;

FIG. 6 is a block diagram illustrating a software configuration of the Web server included in the printing system;

FIG. 7A is a diagram illustrating a display example of a printing content editing screen in a first embodiment;

FIG. 7B is a diagram illustrating an example of a background object;

FIG. 8A is a diagram illustrating an example of a preview screen in a case where no cutting is performed after printing in the first embodiment;

FIG. 8B is a diagram illustrating an example of a preview screen in a case where cutting is performed after printing in the first embodiment;

FIG. 9 is a diagram showing the relationship between FIGS. 9A and 9B;

FIG. 9A is a flowchart illustrating a portion unique to a first operation example in the first embodiment of the printing system;

FIG. 9B is a flowchart illustrating a portion unique to a first operation example in the first embodiment of the printing system;

FIG. 10 is a flowchart illustrating a portion common to first to third operation examples in the first embodiment of the printing system;

FIG. 11 is a diagram showing the relationship between FIGS. 11A and 11B;

FIG. 11A is a flowchart illustrating a portion unique to the second operation example in the first embodiment of the printing system;

FIG. 11B is a flowchart illustrating a portion unique to the second operation example in the first embodiment of the printing system;

FIG. 12 is a flowchart illustrating a portion unique to the third operation example in the first embodiment of the printing system;

FIG. 13 is a diagram illustrating a display example of the printing content editing screen in a second embodiment;

FIG. 14A is a diagram illustrating an example of a preview screen in a case where no cutting is performed after printing in the second embodiment;

FIG. 14B is a diagram illustrating an example of a preview screen in a case where cutting is performed after printing in the second embodiment;

FIG. 15A is a partially enlarged view illustrating an example of a preview screen in a case where no cutting is performed after printing in the second embodiment;

FIG. 15B is a partially enlarged view illustrating an example of a preview screen in a case where cutting is performed after printing in the second embodiment;

FIG. 16 is a flowchart illustrating a part of an operation example in the second embodiment of the printing system;

FIG. 17A is a diagram describing a method of performing change processing on a background object;

FIG. 17B is a diagram describing a method of performing change processing on a background object;

FIG. 17C is a diagram describing a method of performing change processing on a background object;

FIG. 17D is a diagram describing a method of performing change processing on a background object;

FIG. 18A is a diagram describing a method of performing the change processing on the background object and a general object;

FIG. 18B is a diagram describing a method of performing the change processing on the background object and a general object;

FIG. 18C is a diagram describing a method of performing the change processing on the background object and a general object;

FIG. 18D is a diagram describing a method of performing the change processing on the background object and a general object;

FIG. 19A is a diagram describing a method of performing the change processing on the general object;

FIG. 19B is a diagram describing a method of performing the change processing on the general object;

FIG. 19C is a diagram describing a method of performing the change processing on the general object; and

FIG. 19D is a diagram describing a method of performing the change processing on the general object.

### DESCRIPTION OF THE EMBODIMENTS

For example, in some cases, an original document size is changed from a business card size to an A4 size while editing a printing content on a Web application. In this case, the business card size needs cutting, but the A4 size needs neither cutting nor a bleed. Accordingly, in some cases, a user needs to adjust the size of an object that is arranged widely to reach a bleed region during editing so as to fit within a trim line. A bleed data creation system disclosed in Japanese Patent Laid-Open No. 2006-72419 is a system that creates bleed data automatically for DTP data corresponding to the printing content. In the system, the bleed data is created by expanding a rectangular object put in contact with the trim line in the DTP data to the outside of a boundary. However, the user cannot confirm a state of the bleed before printing; for this reason, there may be a case where an undo process occurs after printing such as design adjustment taking into consideration the bleed.

Embodiments are described below in detail with reference to the appended drawings. Note that, the following embodiments are not intended to limit the disclosure according to the scope of claims. Although multiple characteristics are described in the embodiments, not all the combinations of the multiple characteristics are necessarily required for the disclosure, and the multiple characteristics may be combined as needed. In addition, in the appended drawings, the same reference numerals are provided to the same or similar configurations, and duplicated descriptions are omitted in some cases.

### First Embodiment

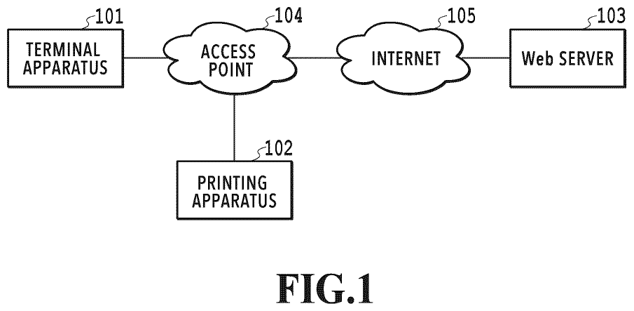

FIG. 1 is a diagram illustrating an example of a configuration of a printing processing system according to the present embodiment. The printing processing system includes a terminal apparatus 101, a printing apparatus 102, and a Web server 103.

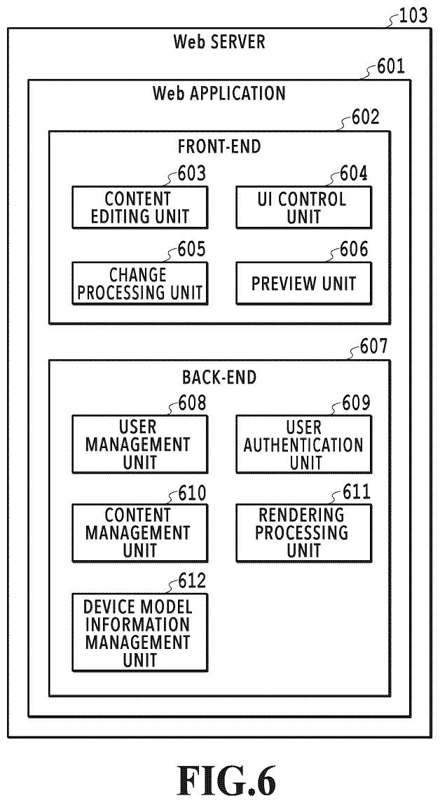

Based on an operation by the user, a Web application 601 (see FIG. 6) provided by the Web server 103 edits and generates a printing content (also referred to simply as a “content”). Image data generated based on content data forming the content is transmitted from the Web server 103 to the printing apparatus 102 by way of the terminal apparatus 101. Based on the image data, the printing apparatus 102 prints the content on a sheet-shaped printing medium such as paper. Hereinafter, the sheet-shaped printing medium such as paper is referred to simply as a “printing medium” regardless of a thickness of the sheet. The printing medium includes both the roll paper and cut paper.

The terminal apparatus 101 is, for example, an information processing apparatus such as a smartphone, a personal computer, a tablet terminal, a mobile phone, a personal digital assistant (PDA), or the like. The printing apparatus 102 is a printer that forms (that is, prints) an image on the printing medium by applying a printing agent such as an ink to the printing medium. The printing apparatus 102 may be a multifunction peripheral having multiple functions such as a copy function, a facsimile function, and a printing function. Note that, in the present embodiment, the printing apparatus 102 is an apparatus that performs printing by an ink jet method; however, it is not limited to this mode, and the printing apparatus 102 may be, for example, an apparatus that performs printing by an electronic photograph method or a thermal sublimation method.

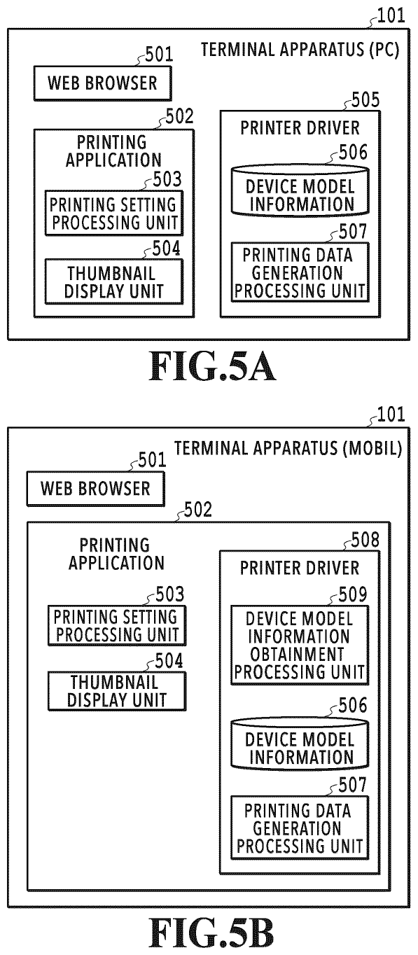

The terminal apparatus 101 communicates with the printing apparatus 102 via a network constructed by an access point 104. Additionally, for example, the access point 104 functions as a wireless LAN router, and the terminal apparatus 101 is connected to the Internet 105 via the access point 104 functioning as the wireless LAN router. Therefore, the terminal apparatus 101 can communicate with the Web server 103 controlling the Web application 601 by way of the Internet 105. The terminal apparatus 101 stores a program such as a printing application 502 (see FIG. 5). Therefore, the terminal apparatus 101 receives the image data created by rendering based on the content data from a rendering processing unit 611 (see FIG. 6) of the Web server 103 and transfers the image data as printing data to the printing apparatus 102 via the network. Note that, the terminal apparatus 101 and the printing apparatus 102 each may be connected with the access point 104 via a wired LAN. Additionally, the terminal apparatus 101 and the printing apparatus 102 may be connected to each other via the wired LAN.

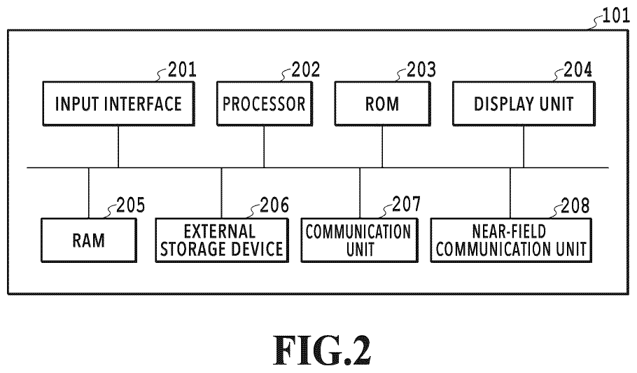

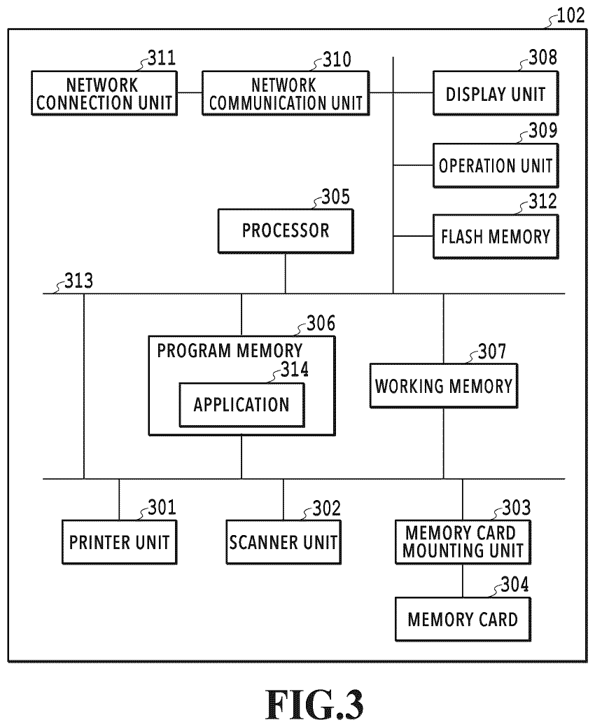

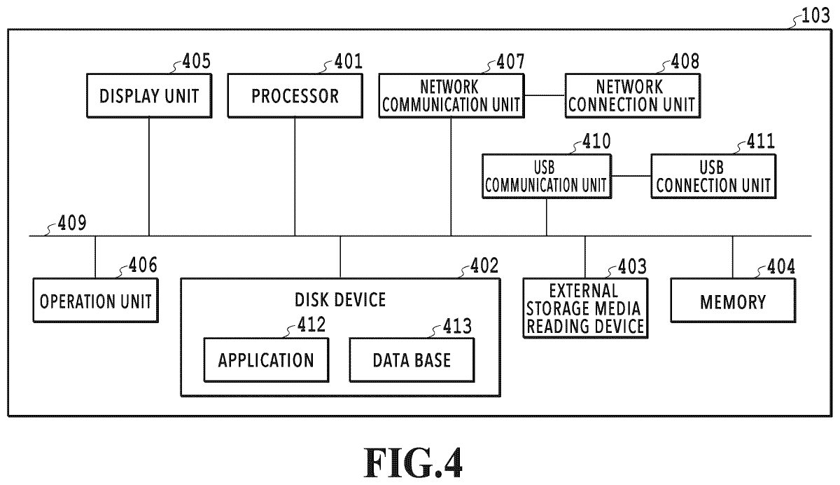

FIG. 2 is a block diagram illustrating an example of a hardware configuration of the terminal apparatus 101. As an example, the terminal apparatus 101 includes an input interface 201, a processor 202 such as a CPU, a ROM 203, a display unit 204, a RAM 205, an external storage device 206, a communication unit 207, and a near-field communication unit 208. Note that, the above-described functional blocks are connected to each other via an internal bus. Additionally, multiple functional blocks may be combined into one, or a single functional block may be divided into two or more functional blocks. The same applies to configurations illustrated in FIGS. 3 and 4.

The processor 202 is a system control unit and controls overall the whole apparatus. The RAM 205 includes, for example, a static RAM (SRAM) or the like that needs a backup power source. Note that, the RAM 205 holds data by a not-illustrated primary battery for data backup, and thus it is possible to store data such as a program control variable without volatilization. A memory region to store setting information, management data, and so on of the terminal apparatus 101 is also provided to the RAM 205. Additionally, the RAM 205 is also used as a main memory and a working memory of the processor 202. The ROM 203 stores fixed data such as a control program executed by the processor 202, a data table, and an OS program. Additionally, the printing application 502 (see FIG. 5) is also stored in the ROM 203. An operation of the terminal apparatus 101 in the present embodiment is implemented with the processor 202 transferring the program stored in the ROM 203 to the RAM 205 and thereafter reading out the program from the RAM 205 to execute, for example.

The display unit 204 includes a light-emitting diode (LED), a liquid crystal display (LCD), and the like and displays a UI screen based on various types of data. Note that, the display unit 204 may include a touch display and the like and have a function to accept various inputs from the user. In other words, the display unit 204 may function as an interface that accepts a data input and an operation instruction from the user. That is, the display unit 204 may be an operation panel including a physical keyboard, a button, a touch panel, and the like.

The communication unit 207 includes a circuit and an antenna to establish communication according to a predetermined wireless communication method. For example, the communication unit 207 can be wirelessly connected to the access point 104. Additionally, in some cases, the communication unit 207 operates as the access point 104 that is temporarily used. The wireless communication used in the present embodiment may be communication for an operation according to a wireless communication method of a wireless LAN complying with IEEE 802.11 standard series (Wi-Fi (“WiFi” is registered trademark)) or may be communication for an operation according to another wireless communication method.

The near-field communication unit 208 executes near-field communication with another apparatus existing within a certain close range from the terminal apparatus 101. Note that, the near-field communication unit 208 establishes communication using a different wireless communication method from that of the communication unit 207. The communication method may be, for example, near field communication (NFC), Bluetooth (registered trademark) Classic, Bluetooth Low Energy (BLE), Wi-Fi Aware, and so on.

FIG. 3 is a block diagram illustrating an example of a hardware configuration of the printing apparatus 102. In the printing apparatus 102, the printing function is implemented by a, a scanner function is implemented by a scanner unit 302, and a storage function is implemented by a memory card mounting unit 303 and a memory card 304.

The printer unit 301 executes printing based on the image data included in the printing data received from outside (for example, the terminal apparatus 101) and the image data stored in the memory card 304. Additionally, the printer unit 301 manages consumable information such as an ink remaining amount and a printing paper remaining amount.

The scanner unit 302 optically reads the original document set on a platen glass (not illustrated) and converts the original document into electronic data. The converted electronic data is further converted into a designated file format, and the converted image data is transmitted to an external apparatus via the network or stored in a saving region (not illustrated) such as an HDD. Additionally, the copy function is implemented by transferring the image data, which is generated with the scanner unit 302 reading the original document set on the platen glass, to the printer unit 301 and printing an image based on the image data on the printing medium by the printer unit 301.

The memory card 304 that can be mounted in the memory card mounting unit 303 that can read and write data stores various types of file data. The file data can be read out and edited by an external apparatus connected to the printing apparatus 102 via the network or an external apparatus not connected to the printing apparatus 102. Additionally, the external apparatus can store the file data into the memory card 304.

In addition, the printing apparatus 102 includes a processor 305 such as a CPU, a program memory 306, a working memory 307, a display unit 308, an operation unit 309, a network communication unit 310, a network connection unit 311, and a flash memory 312. The processor 305 is a processor that controls overall the units in the printing apparatus 102. The program memory 306 includes a ROM and the like and stores various program codes and an application 314 that establishes communication with the Web server 103. Additionally, the application 314 can obtain the consumable information by accessing the printer unit 301 and, for example, transmits a consumable remaining amount to the Web server 103 in a predetermined timing. The working memory 307 includes a RAM and the like and temporarily stores the image data and the like in a case of executing each service and performs buffering. An operation of the printing apparatus 102 in the present embodiment is implemented with the processor 305 reading out the program stored in the program memory 306 to the working memory 307 to execute, for example.

The display unit 308 includes a light-emitting diode (LED), a liquid crystal display (LCD), and the like and displays a UI screen based on various types of data. The operation unit 309 is formed of a switch or the like that allows the user to perform various input operations. The network communication unit 310 is connected with the network such as the Internet 105 via the network connection unit 311 and establishes various communications. Note that, the network communication unit 310 communicates with the outside through a wired LAN and a wireless LAN, for example. The network connection unit 311 in a case where the network communication unit 310 is compatible with the wired LAN is, for example, a connector to connect a cable of the wired LAN, and the network connection unit 311 in a case where the network communication unit 310 is compatible with the wireless LAN is, for example, an antenna. Note that, the network connection unit 311 may be compatible with both the wired LAN and wireless LAN. In the present embodiment, the network communication unit 310 is compatible with the wireless LAN and is connected with the access point 104 according to the wireless communication method of a wireless LAN complying with IEEE 802.11 standard series. The flash memory 312 is a non-volatile memory that stores the image data and the like received by the network communication unit 310. In addition, the above-described units are connected to each other through a bus 313.

The printing apparatus 102 may include a cutting unit that cuts the printing medium on which the printer unit 301 prints the image data. Additionally, a cutting machine may be connected to the terminal apparatus 101 via the access point 104. In this case, the cutting unit and the cutting machine may cut the printing medium based on an instruction from the terminal apparatus 101.

FIG. 4 is a block diagram illustrating an example of a hardware configuration of the Web server 103. A processor 401 such as a CPU is a processor that controls overall the apparatus. A disk device 402 stores various files in addition to an application program 412, a database 413, and an OS read out by the processor 401. An external storage media reading device 403 is a device that reads out information such as a file stored in an external storage medium such as an SD card. A memory 404 includes an RAM and the like, and the processor 401 performs temporal storing, buffering, and the like of the data as needed. An operation of the Web server 103 in the present embodiment is implemented with the processor 401 reading out the program stored in the disk device 402 to the memory 404 to execute, for example.

A display unit 405 includes a light-emitting diode (LED), a liquid crystal display (LCD), and the like and displays a UI screen based on various types of data. An operation unit 406 is formed of a keyboard, a mouse, and the like that allow the user to perform various input operations. A network communication unit 407 is connected with the network such as the Internet 105 via a network connection unit 408 and establishes various communications. Note that, the network communication unit 407 establishes communication through the wired LAN and the wireless LAN, for example. The network connection unit 408 in a case where the network communication unit 407 is compatible with the wired LAN is, for example, a connector to connect the cable of the wired LAN, and the network connection unit 408 in a case where the network communication unit 407 is compatible with the wireless LAN is, for example, an antenna. Note that, the network connection unit 408 may be compatible with both the wired LAN and wireless LAN. A universal serial bus communication unit 410 (USB) is connected with various peripheral devices via a USB connection unit 411 and establishes various communications according to a USB standard. In addition, the above-described units are connected to each other through a bus 409.

### <Configuration of Application>

FIG. 5A is a block diagram illustrating an example of a software configuration in a case where the terminal apparatus 101 is a personal computer. A Web browser 501 is a Web browser, and “Microsoft Edge,” “Google Chrome (registered trademark),” “Firefox (registered trademark),” “Safari (registered trademark),” and so on may be used, for example.

The printing application 502 is an application to perform printing based on printing setting set by the user and includes a printing setting processing unit 503 and a thumbnail display unit 504. For example, the printing application 502 is a native application associated with the Web application 601 and is an application to cause the printing apparatus 102 to print the content created by the Web application 601. The printing setting processing unit 503 sets the printing setting. The thumbnail display unit 504 displays a thumbnail based on the content data created by the printing application 502 based on an operation by the user. In a case where the terminal apparatus 101 is a PC, a printer driver 505 performs processing of generating the printing data to be printed by the printing apparatus 102. The printer driver 505 includes device model information 506 of the printer and a printing data generation processing unit 507. In this case, the printing data generated by the printing data generation processing unit 507 includes the image data. The printer driver 505 is distributed by a vendor of the printer and can be used by being installed by the user. Additionally, in some cases, the printer driver 505 is bundled with the OS. The device model information 506 stores the setting information and the like that can be set in a case of printing by each printer. A usable setting value is, for example, a setting value of a feeding method, a type of the printing paper (including the size), and the like.

FIG. 5B is a block diagram illustrating an example of a software configuration in a case where the terminal apparatus 101 is a mobile terminal. A difference from FIG. 5A is described. In a case where the terminal apparatus 101 is a mobile terminal, there is no printer driver 505. Therefore, the terminal apparatus 101 includes a printing processing module 508 that performs the printing data generation processing. The printing processing module 508 includes a device model information obtainment processing unit 509. The device model information obtainment processing unit 509 obtains the device model information 506 from the printing apparatus 102. Note that, the obtained device model information obtainment processing unit 509 is stored in the external storage device 206, for example.

FIG. 6 is a block diagram illustrating an example of a software configuration of the Web server 103. A front-end 602 mainly controls displaying of the Web browser 501. Specifically, the front-end 602 includes a UI control unit 604 that controls a user operation using the Web browser 501 and a content editing unit 603 that can edit the content created by the Web application 601 according to an editing operation by the user. Additionally, the front-end 602 also includes a change processing unit 605 that performs change processing on an object included in the content and a preview unit 606 that generates a preview of the content and displays a preview screen on the display unit 204. The change processing is to prevent generation of an unintended blank space by a cutting error, and this is described later. A back-end 607 includes a user management unit 608, a user authentication unit 609, a content management unit 610, the rendering processing unit 611, and a device model information management unit 612. The user management unit 608 manages user information identifying the user. For example, the user management unit 608 manages the user information included in a cookie. The user authentication unit 609 issues an identifier unique to each user in association with the user information. The content management unit 610 manages the content data forming the content created by the Web application 601. The rendering processing unit 611 performs rendering processing based on the content data managed by the content management unit 610. The device model information management unit 612 manages the device model information including the device model information and the like of the printing apparatus 102 of the user.

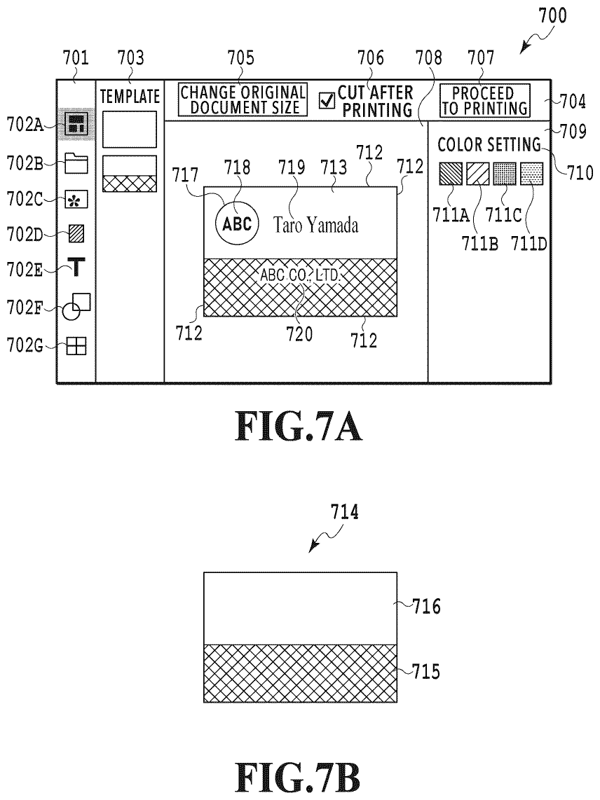

FIG. 7A is a diagram illustrating an example of a printing content editing screen 700 that is displayed by the Web browser 501 on the display unit 204 of the terminal apparatus 101 according to the control by the UI control unit 604 of the front-end 602 of the Web application 601.

A basic menu region 701 is an area in which multiple basic menu items are listed and displayed. In the example in FIG. 7A, a template basic menu item 702A, a file basic menu item 702B, a photograph basic menu item 702C, and a background basic menu item 702D are listed and displayed in the basic menu region 701. Additionally, a text basic menu item 702E, a graphic basic menu item 702F, and a repeated printing basic menu item 702G are also listed and displayed in the basic menu region 701.

The template basic menu item 702A is for selecting a template of any content designed in advance and arranging the template in an editing region 713 according to the operation by the user. The template includes one or more display objects. There are a template including a later-described background object and also a template not including the background object. The content editing unit 603 can edit the printing content including one or more objects in the editing region 713.

The file basic menu item 702B is for selecting any saved content and arranging the content in the editing region 713 according to the operation by the user.

The photograph basic menu item 702C is for selecting any photograph object and arranging the photograph object in the editing region 713 according to the operation by the user.

The background basic menu item 702D is for selecting any background object 714 and arranging the background object 714 in the editing region 713 according to the operation by the user. An existence range of the background object 714 is the entire area of the later-described editing region 713. Accordingly, four sides of the background object 714 coincide with trim lines 712 defining the editing region 713. The background object 714 arranged in the editing region 713 in FIG. 7A is illustrated in FIG. 7B.

The text basic menu item 702E is for arranging a text object including a character string inputted by the user in the editing region 713.

The graphic basic menu item 702F is for selecting any graphic object and arranging the graphic object in the editing region 713 according to the operation by the user. The user can also adjust a size, an angle, and the like of the graphic object.

The repeated printing basic menu item 702G is for repeatedly printing the content created by editing in the editing region 713 on the printing medium. This is described in a second embodiment.

A sub menu region 703 displays a sub menu according to the basic menu item selected by the user from the basic menu region 701 as needed.

In a case where the template basic menu item 702A is selected by the user, the sub menu region 703 displays a list of thumbnails of the templates. Once the user selects any one of the thumbnails of the templates and drags and drops the thumbnail in the editing region 713, the template is arranged in the editing region 713. FIG. 7A illustrates a screen in this case. As seen from the same design, the background object 714 included in the content edited in the editing region 713 is the background object included in the second template from the top of the list. Although this background object includes two portions, which are a lower half portion with a design 715 and a transparent upper half portion, the entire area of the editing region 713 is the existence range.

In a case where the file basic menu item 702B is selected by the user, the sub menu region 703 displays the list of thumbnails of the saved contents. Once the user selects any one of the thumbnails of the contents and drags and drops the thumbnail in the editing region 713, the content is arranged in the editing region 713. Note that, a description related to a screen and an operation to save the content is omitted.

In a case where the user selects the photograph basic menu item 702C, the sub menu region 703 displays a list of thumbnails of the photographs. Once the user selects any one of the thumbnails of the photographs and drags and drops the thumbnail in the editing region 713, the photograph is arranged in the editing region 713. Note that, a description related to a screen and an operation to save the photograph is omitted.

In a case where the user selects the background basic menu item 702D, the sub menu region 703 displays the list of thumbnails of the backgrounds. Once the user selects any one of the thumbnails of the backgrounds and drags and drops the thumbnail in the editing region 713, the background is arranged in the editing region 713. The list of the thumbnails of the backgrounds may include the thumbnail of the illustrated background object 714.

In a case where the user selects the text basic menu item 702E, the sub menu region 703 is not particularly changed. In this case, a pop-up menu to select a vertical text or a horizontal text is displayed, and once the user selects either one of the texts, a state that allows for arrangement of the text in the editing region 713 is obtained. A character string 718 of “ABC,” a character string 719 of “Taro Yamada,” and a character string 720 of “ABC Co., Ltd.” included in the content displayed in the editing region 713 are inputted and arranged by the above-described method. Note that, the character string may be obtained by changing a text (not illustrated) existing in the template from the beginning.

In a case where the user selects the graphic basic menu item 702F, the sub menu region 703 is not particularly changed. In this case, a pop-up menu to select a line, a rectangular, or an ellipse is displayed, and once the user selects any one of the graphics, a state that allows for arrangement of the selected graphic in the editing region 713 is obtained. A circular graphic 717 included in the content existing in the editing region 713 is arranged by the above-described method. Note that, the graphic 717 may be a graphic (not illustrated) existing in the template from the beginning.

Note that, the object such as the text and the graphic may be arranged so as to partially protrude from the editing region 713. Note that, since the range of the content is only the entire area of the editing region 713, in this case, the protruding portion is cut off from the content. That is, although the object itself remains with no change, the protruding portion is processed as a portion that is not printed.

In a control region 704, three control objects, which are a “change original document size” button 705, a “cut after printing” checkbox 706, and a “proceed to printing” button 707, are arranged.

The “change original document size” button 705 is for the user to change an original document size. In a case where the user presses the “change original document size” button 705, a screen (not illustrated) including a menu to select the original document size is displayed. The user can select the original document size from the menu. It is also possible to change the original document size by utilizing the menu. For example, even in a case where a postcard size is selected as the original document size at first and the content is edited, it is possible to change the original document size to the A4 size from the middle. In printing, the printing paper in the original document size selected at first or the original document size after change is selected. The same applies to the repeated printing in the second embodiment.

The checkbox 706 of “cut after printing” is for the user to designate whether to cut the printing medium on which the content is printed by the cutting machine and the like. In a case where the user presses the checkbox 706 of “cut after printing,” ON/OFF of the check is toggled. Additionally, for example, in a case where the business card size is selected, the check may be accordingly toggled to ON as an initial value.

The “proceed to printing” button 707 is to execute printing after the preview is displayed by an instruction from the user. Details thereof are described later.

In a work region 708, the editing region 713 surrounded by a rectangular formed of the four trim lines 712 is arranged. An existence range of the content is the editing region 713. Accordingly, in a case where the object is arranged so as to partially protrude from the editing region 713 as described above, only the portion that does not protrude is included in the content. In addition, the protruding portion is not displayed in the work region 708. Accordingly, the user can visually confirm the object included in the content whose existence range is the editing region 713.

Whether the check of the “cut after printing” checkbox 706 is ON or OFF, the existence range of the content coincides with the editing region 713. Accordingly, even in a case where the check of the “cut after printing” checkbox 706 is ON, the user can edit the content similarly to a case of OFF. Particularly, even in a case where the check of the “cut after printing” checkbox 706 is ON, the user does not need to perform the bleed processing by himself/herself. As described later, the bleed processing is performed in a case where the Web application 601 executes previewing of the content in a case where the check of the “cut after printing” checkbox 706 is ON.

An editing menu region 709 displays a screen to edit the object that is selected currently. In the example illustrated in FIGS. 7A and 7B, designs 711A to 711D, which can be replaced from the design 715 of the background object 714 that is selected currently, are displayed.

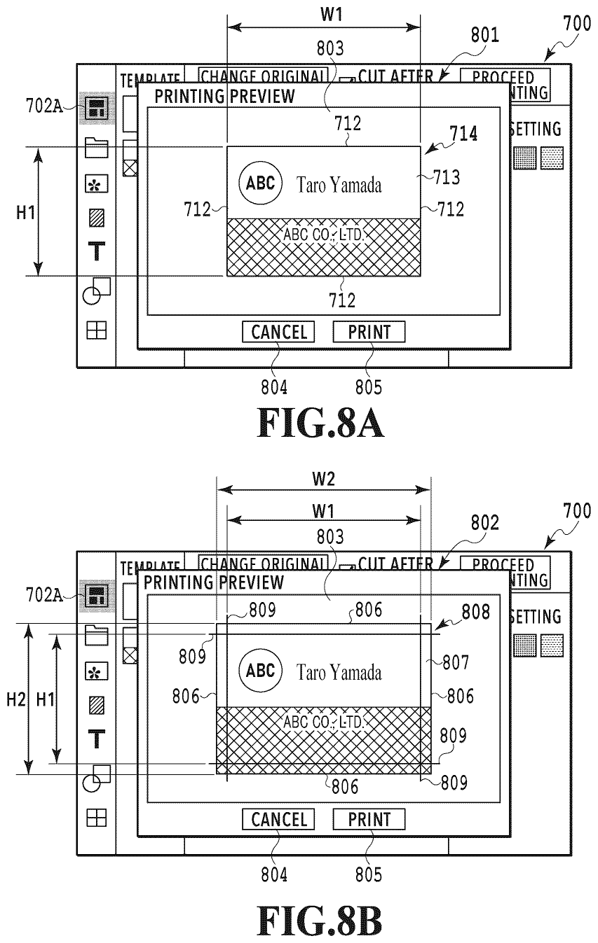

FIGS. 8A and 8B each illustrate a preview screen that is displayed on the display unit 204 of the terminal apparatus 101 by the front-end 602 included in the Web application 601.

The user presses the “proceed to printing” button 707 arranged in the printing content editing screen 700 illustrated in FIG. 7A. Then, a preview screen 801 as illustrated in FIG. 8A or a preview screen 802 as illustrated in FIG. 8B is displayed on the printing content editing screen 700. In a case where setting of not performing the cutting processing after printing is set to the “cut after printing” checkbox 706 (that is, in a case where the checkbox 706 is OFF), the preview screen 801 illustrated in FIG. 8A is displayed. In a case where setting of performing the cutting processing after printing is set to the “cut after printing” checkbox 706 (that is, in a case where the checkbox 706 is ON), the preview screen 802 illustrated in FIG. 8B is displayed.

In a preview region 803 included in the preview screen 801, the preview of the content whose existence range is the editing region 713 surrounded by the trim lines 712 from four sides is displayed. The existence range of the background object 714 is the editing region 713 as with the content.

In the preview region 803 included in the preview screen 802, the preview of the content including an expanded background object 808 whose existence range is an expanded region 807 surrounded by bleed lines 806 from four sides is displayed. A method of changing the background object 714 into the expanded background object 808 is described later. Note that, although the existence range of the expanded background object 808 is equal to the expanded region 807 in the example in FIG. 8B, it is not necessarily limited thereto. The existence range may be anything as long as the existence range of the expanded background object 808 includes the expanded region 807. This is described later. Additionally, in the preview screen 802, even in a case where the expanded background object 808 includes a portion protruding from the expanded region 807, the protruding portion is not displayed and is not printed.

In the preview region 803 included in the preview screen 802, four cutting lines 809 are also displayed so as to overlap with the preview of the content including the expanded background object 808. Each cutting line 809 is obtained by extending the corresponding trim line 712 to go across the expanded region 807 and indicates cutting of the printing medium by the cutting machine while targeting the cutting line 809. Note that, the cutting line 809 is displayed to overlap with the preview of the content including the expanded background object 808 but is not printed on the printing medium. Note that, a crop mark (not illustrated) or the like corresponding to the cutting line 809 may be printed so as not to affect the printed product after cutting.

The cutting line 809 is displayed on the preview screen 802 mainly for the purpose of allowing the user to identify that the content includes the object that is extensionally colored to the outside of the range of the editing region 713. Accordingly, the cutting line 809 may be changed to a display object corresponding to the above-described purpose. For example, the cutting lines 809 may be replaced with the trim lines 712 surrounding the editing region 713 from four sides. Additionally, the cutting lines 809 each may be replaced with an L-shaped display object indicating each of four corners of the editing region. In addition, the portion protruding from the editing region 713 and extensionally colored may be displayed dark, displayed light instead, or displayed with hatching.

In this case, even in a case where the printing medium is cut while targeting the position of the cutting line 809, in general, the actual cutting position is displaced from the position of the cutting line 809. That is, a cutting error may occur between the targeting cutting line 809 and the actual cutting line (not illustrated). In a case where no conversion processing (bleed processing) is performed on the object (for example, the background object 714) including the portion put in contact with the trim line 712, if there is the cutting error, an unintended blank space is generated between the edge of the printing medium after cutting and the above-described object. The blank space is a portion in which no printing is performed. However, in a case where the conversion processing (the bleed processing) is performed on the object including the portion put in contact with the trim line 712, even if there is the cutting error, it is possible to avoid the generation of the above-described blank space. Particularly, it is possible to reliably avoid the generation of the blank space by properly setting a distance between the trim line 712 and the bleed line 806 and extensionally coloring the object including the portion put in contact with the trim line 712 to reach the bleed line 806 in the conversion processing. Accordingly, it is possible to say that the bleed line 806 is a line as a guide for avoiding the generation of the blank space. As a distance ΔE between the trim line 712 and the bleed line 806, for example, the maximum cutting error that can be expected is used. Alternatively, as the distance ΔE, n*σ is obtained where a standard deviation of the cutting error is σ. In this case, it is possible to determine a value of n arbitrarily and, for example, the value may be around 3 to 6.

In FIG. 8B, a distance between right and left cutting lines 809 in actual scale is represented by W1, and a distance between right and left bleed lines 806 in actual scale is represented by W2. W2 is set to obtain ΔE=(W2−W1)/2. Likewise, in FIG. 8B, a distance between top and bottom cutting lines 809 is represented by H1, and a distance between top and bottom bleed lines 806 is represented by H2. H2 is set to obtain ΔE=(H2−H1)/2. W1 is different depending on the size of the printing medium, and accordingly a ratio of EA to W1 is also different depending on the size of the printing medium. Likewise, H1 is different depending on the size of the printing medium, and accordingly a ratio of ΔE to H1 is also different depending on the size of the printing medium. Accordingly, the size of the expanded region 807 in a case of normalization based on the size of the editing region 713 may be changed depending on the size of the printing medium or may be fixed to match the minimum size of the printing medium.

In a case where the user prints the not-expanded content that is displayed on the preview screen 801 and determines that there is a problem, the user presses a “cancel” button 804. Thus, displaying of the preview screen 801 ends, and the printing content editing screen 700 is focused again.

In a case where the user prints the not-expanded content that is displayed on the preview screen 801 and determines that there is no problem, the user presses a “print” button 805. Thus, the printing application 502 is activated, and the not-expanded content is printed on the printing medium by the printing apparatus 102. Also in this case, displaying of the preview screen 801 ends, and the printing content editing screen 700 is focused again.

In a case where the user prints the content with the expanded background object that is displayed on the preview screen 802, and determines that there is a problem, the user presses the “cancel” button 804. Thus, displaying of the preview screen 801 ends, and the printing content editing screen 700 is focused again.

In a case where the user prints the content with the expanded background object that is displayed on the preview screen 802, and determines that there is no problem, the user presses the “print” button 805. Thus, the printing application 502 is activated, and the content with the expanded background object is printed on the printing medium by the printing apparatus 102. Also in this case, displaying of the preview screen 801 ends, and the printing content editing screen 700 is focused again. Thereafter, the printing medium on which the content with the expanded background object is printed is cut by the cutting machine or the cutting unit. The cutting machine or the cutting unit may be controlled by the Web application 601.

In a case where the printing content editing screen 700 is focused again, the content before the background object is expanded is maintained or restored by later-described processing. Here, a use case is described. For example, the user confirms the content with the expanded background object that is displayed as a preview on the preview screen 802. Then, with the existence of the bleed portion, the user notices that the check of the “cut after printing” checkbox 706 is ON by mistake and presses the “cancel” button 804. In this case, the user switches the check of the “cut after printing” checkbox 706 from ON to OFF and then presses the “proceed to printing” button 707 again. Thereafter, by way of displaying of the preview screen 801, it is possible to cause the printing apparatus 102 to print the content with the not-expanded background object on the printing medium.

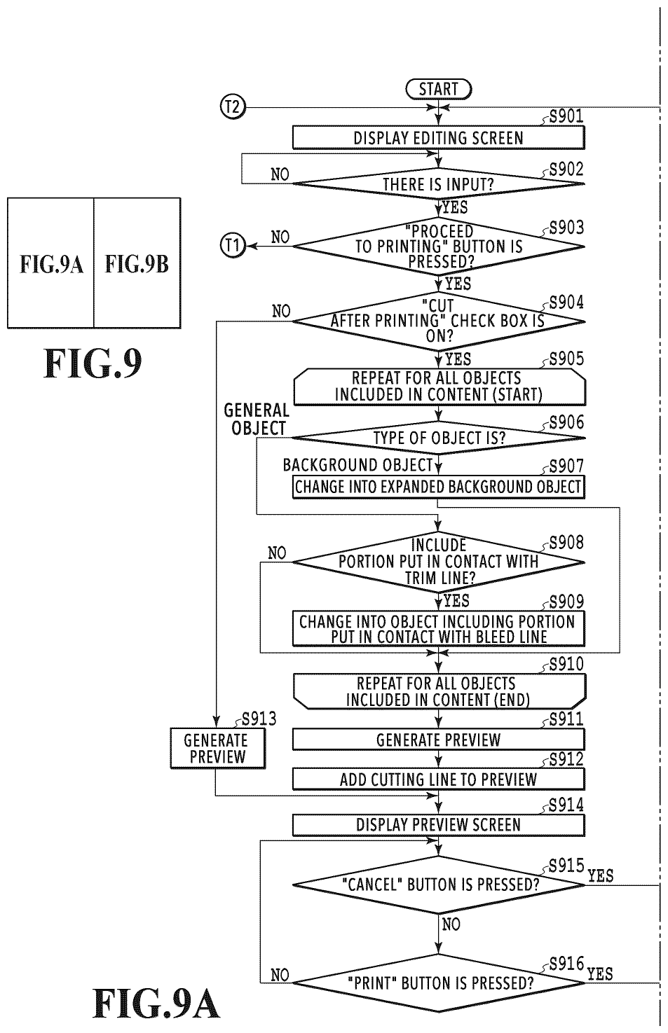

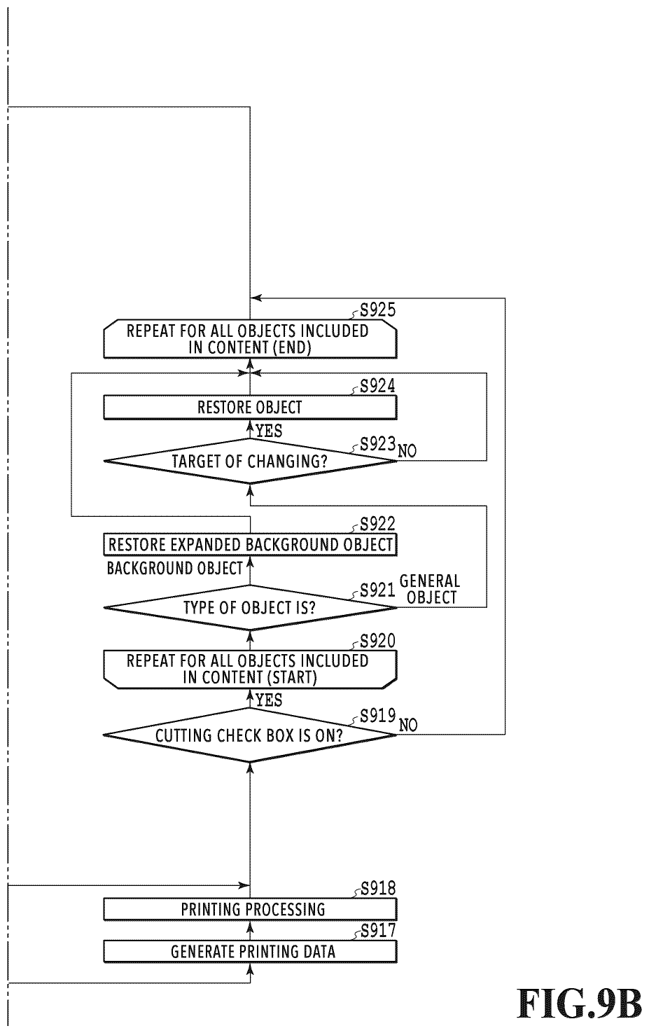

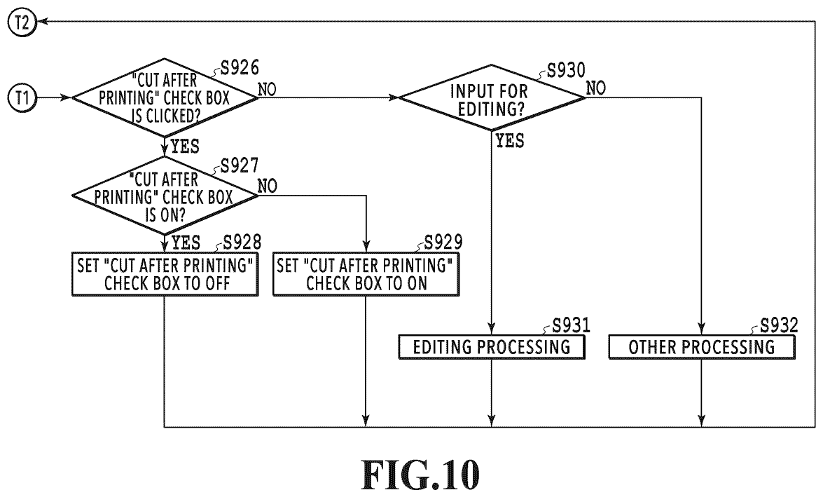

FIGS. 9 and 10 are flowcharts illustrating an example of a method performed by the front-end 602 after the Web browser 501 accesses the Web application 601 according to the operation by the user. The front-end 602 may be a program executed by the Web server 103, may be a program executed on the Web browser 501 in the terminal apparatus 101, or may be a combination of both of the above. Accordingly, the front-end 602 is executed by the processor 401, the processor 202, or both. Accordingly, in the following descriptions, the method executed by the front-end 602 is physically executed by the processor 401, the processor 202, or both that reads out the front-end 602 and operates according to a command included in the front-end 602.

In S901, the front-end 602 receives the printing content editing screen 700 in FIG. 7A from the back-end 607 and displays the printing content editing screen 700 on the display unit 204 via the browser 501.

Next, in S902, the front-end 602 waits for an input to the printing content editing screen 700 by the user. The input is performed by an operation on an input function unit included in the display unit 204.

Once there is the input, in S902, the front-end 602 determines as YES and allows the processing to proceed to S903.

In S903, the front-end 602 determines whether the input is pressing of the “proceed to printing” button 707.

If the input is pressing of the “proceed to printing” button 707, the front-end 602 allows the processing to proceed to S904, and if not, the front-end 602 allows the processing to proceed to S926.

In S926, the front-end 602 determines whether the input is a mouse-click on the “cut after printing” checkbox 706.

If the input is the mouse-click on the “cut after printing” checkbox 706, the front-end 602 allows the processing to proceed to S927, and if not, the front-end 602 allows the processing to proceed to S930.

In S927, the front-end 602 determines whether the “cut after printing” checkbox 706 is ON.

If the “cut after printing” checkbox 706 is ON, the front-end 602 allows the processing to proceed to S928, and if not, the front-end 602 allows the processing to proceed to S929.

In S928, the front-end 602 sets the “cut after printing” checkbox 706 to OFF. On the other hand, in S929, the front-end 602 sets the “cut after printing” checkbox 706 to ON.

In S930, the front-end 602 determines whether the input is an input for editing the content (that is, an input related to the editing operation).

If the input is the input for editing the content, the front-end 602 allows the processing to proceed to S931, and if not, the front-end 602 allows the processing to proceed to S932.

In S931, the front-end 602 executes the editing processing of the content. In S932, the front-end 602 executes other processing.

Once S928, S929, S931, or S932 is executed, the front-end 602 returns the processing to S901.

In S904, the front-end 602 determines whether the “cut after printing” checkbox 706 is ON.

If the “cut after printing” checkbox 706 is ON, the front-end 602 allows the processing to proceed to repeating processing from S905 to S910, and if not, the front-end 602 allows the processing to proceed to S913.

The repeating processing from S905 to S910 is repeated for all the objects included in the content.

In each repeating, first, in S906, the front-end 602 determines the type of the object in the current repeating.

If the object in the current repeating is the background object, the front-end 602 allows the processing to proceed to S907, and if the object is a general object, the front-end 602 allows the processing to proceed to S908. In this case, the general object is an object other than the background object.

In S907, the front-end 602 changes the background object to the expanded background object and then ends the current repeating. Since the expanded background object includes the portion put in contact with the bleed line 806, even in a case where the cutting error occurs, no unintended blank is generated between the edge of the printing medium after cutting and the expanded background object.

In S908, the front-end 602 determines whether the general object in the current repeating includes the portion put in contact with the trim line 712.

If the general object in the current repeating includes the portion put in contact with the trim line 712, the front-end 602 allows the processing to proceed to S909, and if not, the front-end 602 ends the current repeating.

In S909, the front-end 602 changes the general object in the current repeating into the object including the portion put in contact with the bleed line 806 and then ends the current repeating. The portion put in contact with the bleed line 806 of the general object after change corresponds to the portion put in contact with the trim line 712 of the general object before change. Since the general object after change includes the portion put in contact with the bleed line 806, even in a case where the cutting error occurs, no unintended blank is generated between the edge of the printing medium after cutting and the general object after change. Note that, as described later, in S909, the front-end 602 may change the general object in the current repeating into an object that further includes a portion away from the editing region 713 farther than the bleed line 806. Note that, in this case, as long as printing is performed to reach the portion put in contact with the bleed line 806 of the above-described general object, it is unnecessary to print the portion away from the editing region 713 farther than the bleed line 806.

At the point of ending the repeating from S905 to S910, an original content is converted into the expanded content in which no unintended blank is generated even in a case where the cutting error occurs.

In S911, the front-end 602 generates the preview based on the expanded content.

Next, in S912, the front-end 602 adds the cutting line 809 to the preview generated in S911. Note that, the cutting line 809 may be added to the preview in generating the preview in S911. In either case, the cutting line 809 is not added to the expanded content itself, and the cutting line 809 is not printed. Note that, the above-described crop mark may be added to the expanded content to be printed.

In S913, the front-end 602 generates the preview based on the original content. No cutting line is added to the preview.

Subsequent to S912 or S913, in S914, the front-end 602 displays the preview screen. In this process, if the processing proceeds from S912 to S914, the front-end 602 displays the preview screen 802. Additionally, if the processing proceeds from S913 to S914, the front-end 602 displays the preview screen 801.

Next, in a loop of S915 and S916, the front-end 602 waits until the user presses the “cancel” button 804 or the “print” button 805.

If the “cancel” button 804 is pressed, the front-end 602 allows the processing to proceed to S919, and if the “print” button 805 is pressed, the front-end 602 starts S917 and allows the processing to proceed to S919 concurrently. Note that, the processing may proceed to S919 after ending of S917 or S918 is confirmed.

In S917, the printing application 502 is activated. The printing application 502 requests the back-end 607 to provide the printing data. In response to this, the back-end 607 performs the rendering processing by the rendering processing unit 611 based on the holding content and transmits the result to the printing application 502. In response to this, the terminal apparatus 101 transmits the printing data to the printing apparatus 102 via the printing application 502 and the printer driver 505.

In S918, the printing apparatus 102 receives the printing data from the terminal apparatus 101 and executes the printing processing based on the printing data.

The content held by the back-end 607 is the original content in a case where the “cut after printing” checkbox 706 is OFF and is the expanded content in a case where the “cut after printing” checkbox 706 is ON. Accordingly, in a case where the “print” button 805 is pressed in a period of time of displaying the preview screen 801 or 802 according to ON/OFF of the “cut after printing” checkbox 706, the printing application 502 is activated. Then, in the printing processing, the original content or the expanded content is printed according to ON/OFF of the “cut after printing” checkbox 706.

In S919, the front-end 602 determines whether the “cut after printing” checkbox 706 is ON.

If the “cut after printing” checkbox 706 is ON, the front-end 602 allows the processing to proceed to repeating processing from S920 to S925, and if the “cut after printing” checkbox 706 is OFF, the front-end 602 returns the processing to S901.

The repeating processing from S920 to S925 is repeated for all the objects included in the content. The content in this case is the expanded content.

In each repeating, first, in S921, the front-end 602 determines the type of the object in the current repeating.

If the object in the current repeating is the background object, the front-end 602 allows the processing to proceed to S922, and if the object is the general object, the front-end 602 allows the processing to proceed to S923.

In S922, the front-end 602 restores the expanded background object to the not-expanded background object.

In S923, the front-end 602 determines whether the general object in the current repeating is the object after change in S909.

If the general object in the current repeating is the object after change in S909, the front-end 602 allows the processing to proceed to S924, and if not, the front-end 602 ends the current repeating.

In S924, the front-end 602 restores the general object in the current repeating to the object before change.

At the point of ending the repeating from S920 to S925, the expanded content is restored to the original content.

Once the repeating from S920 to S925 ends, the front-end 602 returns the processing to S901.

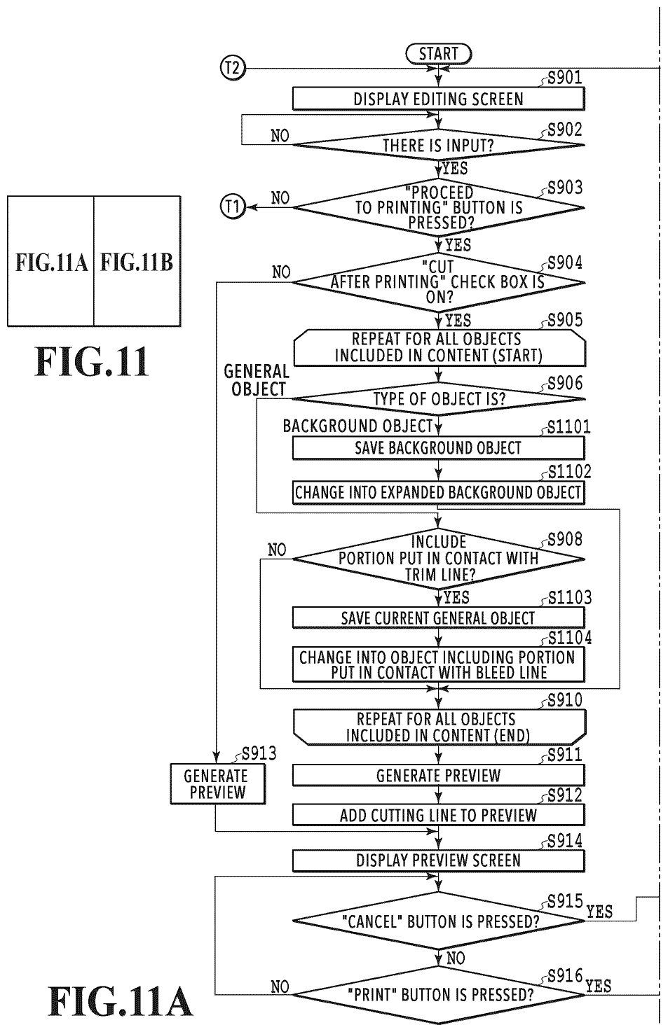

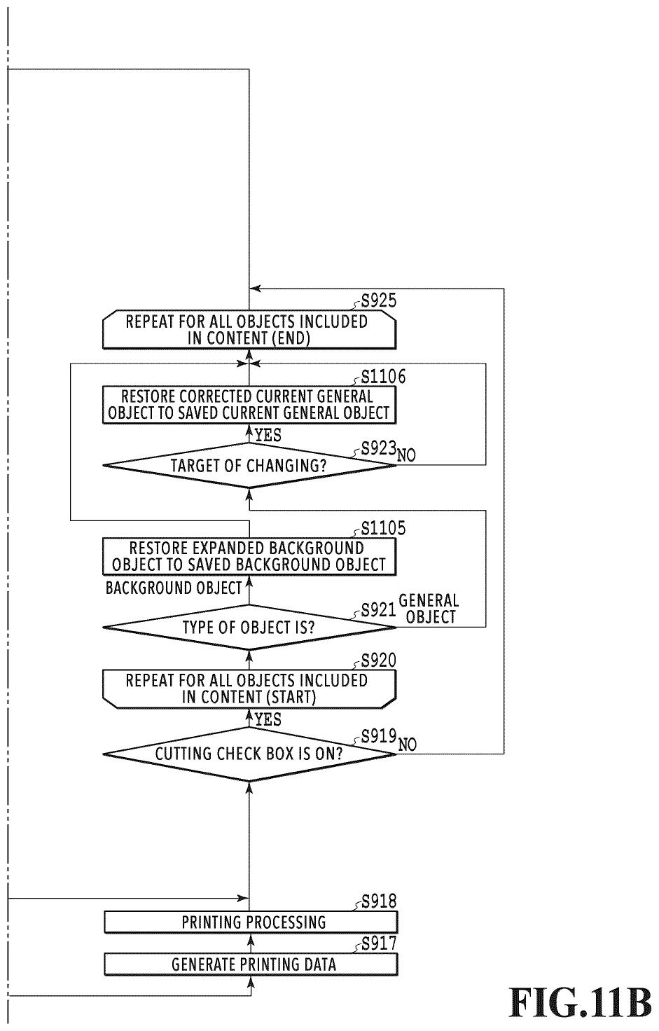

In the method illustrated in FIGS. 9 and 10, in the processing from S920 to S925, the object after change in S907 or S909 is restored to the object before change based on the object after change. However, the object before change may be saved and then restored later. Accordingly, the portion illustrated in FIG. 9 may be changed as that illustrated in FIG. 11.

Out of steps illustrated in FIG. 11, a step different from the step illustrated in FIG. 9 is described.

If it is determined in S906 that the object in the current repeating is the background object, in S1101, the front-end 602 saves the background object. Next, in S1102, the front-end 602 changes the background object into the expanded object. In a case of the method illustrated in FIG. 9, it is necessary in S907 to change the background object so as to be able to restore the background object before expansion based on the background object after expansion in S922. In contrast, in a case of the method illustrated in FIG. 11, it is unnecessary in S1102 to change the background object as described above.

If it is determined in S908 that the general object in the current repeating includes the portion put in contact with the trim line 712, in S1103, the front-end 602 saves the current general object. Next, in S1104, the front-end 602 changes the general object including the portion put in contact with the trim line 712 into the general object including the portion put in contact with the bleed line. In a case of the method illustrated in FIG. 9, it is necessary in S909 to change the general object so as to be able to restore the general object before change based on the general object after change in S924. In contrast, in a case of the method illustrated in FIG. 11, it is unnecessary in S1104 to change the general object as described above.

If it is determined in S921 that the object in the current repeating is the background object, in S1105, the front-end 602 restores the expanded background object to the background object saved in S1101.

If it is determined in S923 that the general object in the current repeating is the general object after change in S1104, in S1106, the front-end 602 restores the general object after change to the general object saved in S1103.

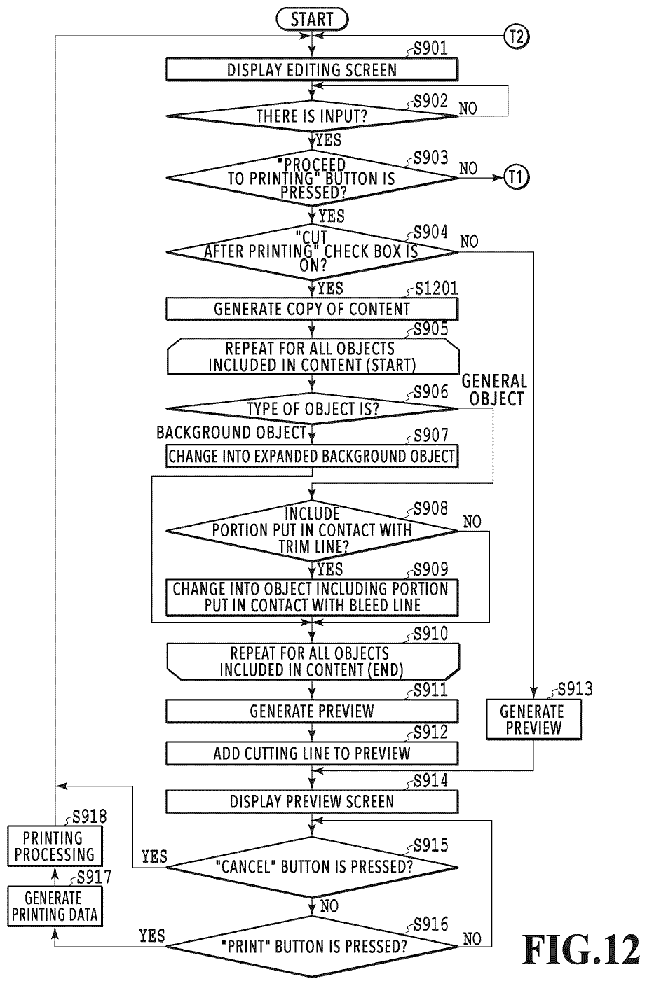

In the method illustrated in FIG. 11, the object before change is saved and then restored later. However, the entire content before change may be saved and then restored later. Accordingly, the portion illustrated in FIG. 9 may be changed as that illustrated in FIG. 12.

Out of steps illustrated in FIG. 12, a step different from the step illustrated in FIG. 9 is described.

If it is determined in S904 that the “cut after printing” checkbox 706 is ON, in S1201 before proceeding to the repeating processing from S905 to S910, the front-end 602 generates a copy of the content.

In the repeating processing from S905 to S910, the object included in the copy of the content is a target of the processing.

In S911, the front-end 602 generates the preview based on the copy of the content as the target of the repeating processing from S905 to S910.

If the “cut after printing” checkbox 706 is ON, the processing proceeds from S912 to S914. Then, in S917, the printing data is generated based on the copy of the content as the target of the repeating processing from S905 to S910.

In the method illustrated in FIG. 12, the processing of restoring the original content is unnecessary; for this reason, if it is determined as YES in S915, the processing returns to S901. Additionally, if it is determined as YES in S916, S917 is started, and the processing returns to S901 concurrently.

### Second Embodiment

The second embodiment corresponds to the repeated printing in which multiple contents are printed on a single printing medium. In the following descriptions, the same contents are repeatedly printed on the single printing medium. A basic configuration and operation of the second embodiment are similar to that of the first embodiment; for this reason, a duplicated description is omitted, and only a different portion is described.

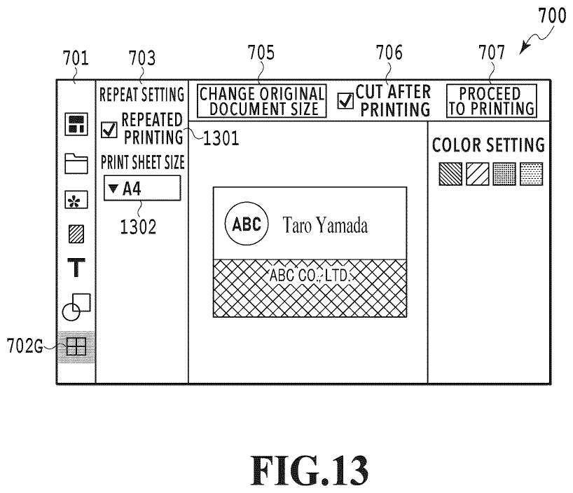

As illustrated in FIG. 13, in a case where the repeated printing basic menu item 702G in the basic menu region 701 is selected, the sub menu region 703 displays a “repeated printing” checkbox 1301 and a “print sheet size” combo box 1302. The “repeated printing” checkbox 1301 is for the user to select whether to perform the repeated printing. The “print sheet size” combo box 1302 is for the user to select the size of the printing medium on which the repeated printing is performed.

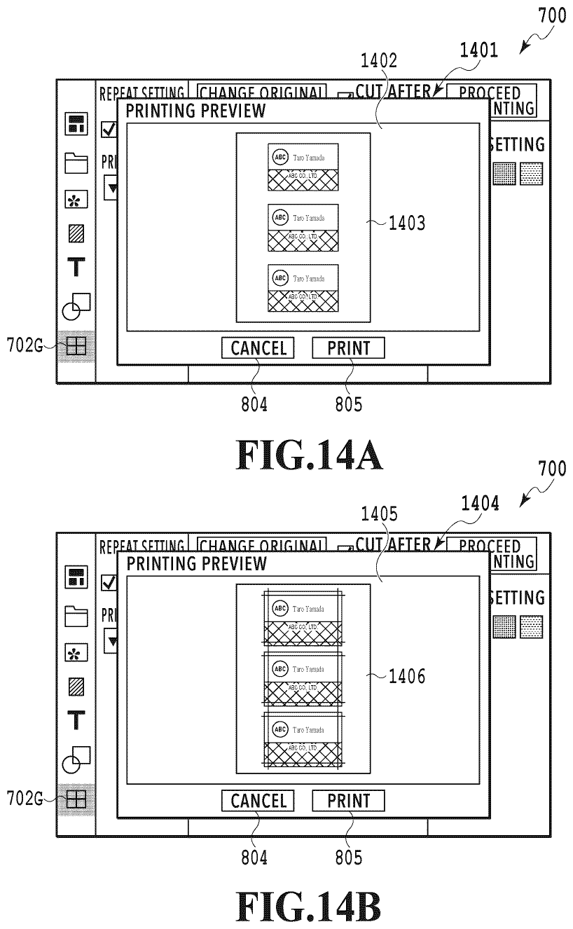

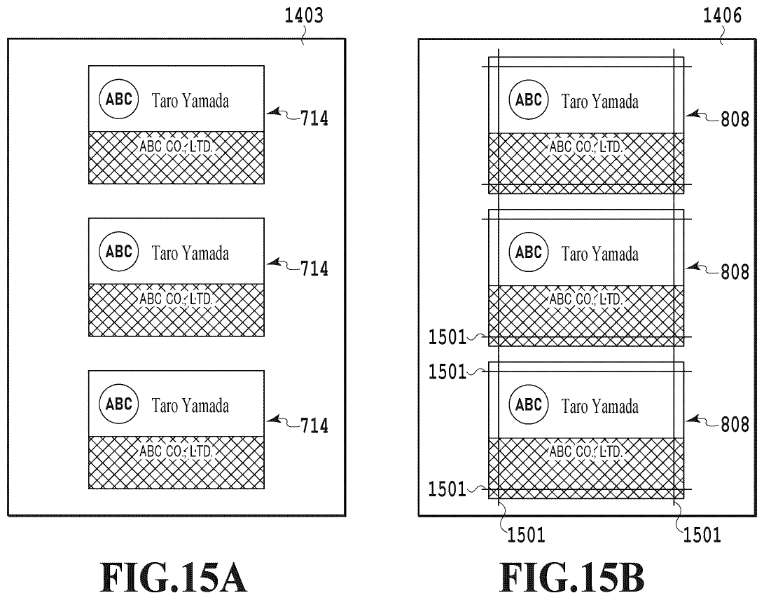

In a case where the “repeated printing” checkbox 1301 is ON while the “cut after printing” checkbox 706 is OFF, the user presses the “proceed to printing” button 707. Accordingly, a preview screen 1401 as illustrated in FIG. 14A is displayed on the printing content editing screen 700. As illustrated in FIG. 14A and FIG. 15A that is partially enlarged, a preview region 1402 of the preview screen 1401 displays a preview of a printing medium 1403 on which the content including the not-expanded background object 714 is repeatedly arranged.

In a case where the “repeated printing” checkbox 1301 is ON while the “cut after printing” checkbox 706 is ON, the user presses the “proceed to printing” button 707. Accordingly, a preview screen 1404 as illustrated in FIG. 14B is displayed on the printing content editing screen 700. As illustrated in FIG. 14B and FIG. 15A that is partially enlarged, a preview region 1405 of the preview screen 1404 displays a preview of a printing medium 1406 on which the content including the expanded background object 808 is repeatedly arranged. The preview displays an overlapped cutting line 1501. The cutting line 1501 corresponds to multi-printing. That is, the cutting line 1501 is for a case where the multiple contents are obtained from a single printing medium by cutting the printing medium for each content.

In a case where the user presses the “print” button 805 arranged on the preview screen 1401, the multiple contents including the not-expanded background object 714 are printed on the printing medium designated by the “print sheet size” combo box 1302. In a case where the user presses the “print” button 805 arranged on the preview screen 1404, the multiple contents including the expanded background object 808 are printed on the printing medium designated by the “print sheet size” combo box 1302.

Note that, it may be assumed that cutting is always performed after printing in a case of the repeated printing. In this case, once the “proceed to printing” button 707 is pressed, the preview screen 1404 may be always displayed to perform printing corresponding to the preview screen 1404.

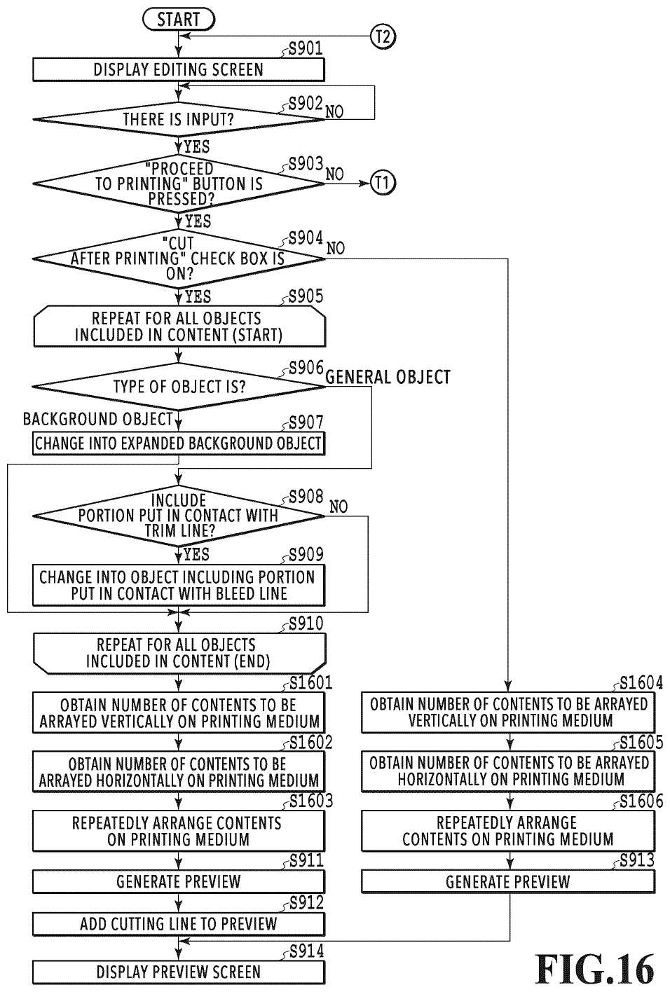

FIG. 16 is a flowchart illustrating a part of an operation example in the second embodiment. This is based on a first operation example in the first embodiment illustrated in FIG. 9. In the operation example in the second embodiment, S1601 to S1603 are inserted between S910 and S911. Additionally, if it is determined as NO in S904, S1604 to S1606 are inserted before S913. In the operation example in the second embodiment, S915 to S925 are common to the first operation example in the first embodiment; for this reason, those steps are omitted in FIG. 16. The operation example in the second embodiment also includes the processing illustrated in FIG. 10.

In S1601, the front-end 602 obtains the number of the objects including the expanded background object 808 that are to be arrayed vertically on the printing medium in the size selected by the “print sheet size” combo box 1302.

In S1602, the front-end 602 obtains the number of the objects including the expanded background object 808 that are to be arrayed horizontally on the printing medium in the size selected by the “print sheet size” combo box 1302.

In S1603, the front-end 602 repeatedly arrays the objects including the expanded background object 808 on the printing medium based on the numbers obtained in S1601 and S1602.

In S911, the front-end 602 generates the preview of the printing medium 1406, and in S912, the front-end 602 adds the cutting line 1501 to the preview. In this case, in S914, the front-end 602 displays the preview screen 1404 on the display unit.

In S1604, the front-end 602 obtains the number of the objects including the not-expanded background object 714 that are to be arrayed vertically on the printing medium in the size selected by the “print sheet size” combo box 1302.

In S1605, the front-end 602 obtains the number of the objects including the not-expanded background object 714 that are to be arrayed horizontally on the printing medium in the size selected by the “print sheet size” combo box 1302.

In S1606, the front-end 602 repeatedly arrays the objects including the not-expanded background object 714 on the printing medium based on the numbers obtained in S1604 and S1605.

In S913, the front-end 602 generates the preview of the printing medium 1403. In this case, in S914, the front-end 602 displays the preview screen 1401 on the display unit.

Note that, for example, in S1601, the number of the contents to be arrayed vertically may be obtained based on a vertical size of the printing medium selected by pressing the “change original document size” button 705 and a vertical size of the printing medium selected by the “print sheet size” combo box 1302. Additionally, for example, in S1602, the number of the contents to be arrayed horizontally may be obtained based on a horizontal size of the printing medium selected by pressing the “change original document size” button 705 and a horizontal size of the printing medium selected by the “print sheet size” combo box 1302. The same applies to S1604 and S1605. However, it is not limited thereto and, for example, the numbers of the contents to be arrayed vertically and horizontally may be designated by the user.

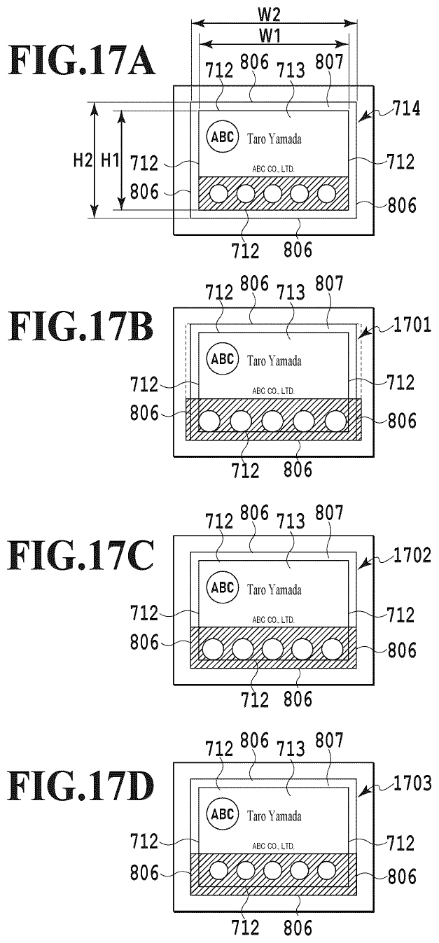

FIGS. 17A to 17D are diagrams describing methods in three ways to expand the background object. FIG. 17A illustrates the content including the not-expanded background object 714. FIGS. 17B to 17D each illustrate the content including background objects 1701 to 1703 expanded by first to third methods.

The expanded background object 1701 illustrated in FIG. 17B is the background object 714 enlarged such that the background object 1701 includes the expanded region 807 in the existence range and aspect ratios of the background object 714 and the background object 1701 coincide with each other. Accordingly, the background object 1701 includes a portion protruding rightward and leftward from the expanded region 807. The portion protruding rightward and leftward as described above is not displayed on the preview screen 802 in the reality and not printed.

The expanded background object 1702 illustrated in FIG. 17C is the background object 714 enlarged such that the existence range of the background object 1702 coincides with the expanded region 807. Accordingly, the aspect ratios of the background object 714 and the background object 1701 are different. Additionally, the background object 1701 does not include the portion protruding rightward and leftward from the expanded region 807.

The expanded background object 1703 illustrated in FIG. 17D is obtained by adding the bleed portion to the background object 714. Accordingly, the image content of the portion existing in the editing region 713 of the background object 1703 coincides with the image content of the background object 714. The image content of a portion (the bleed portion) existing outside the editing region 713 of the background object 1703 may be prepared in advance or may be generated based on the image content of the background object 714. For the generation of the image content, for example, a space filter to insert the image data may be used, or a learned model generated by machine learning may be used.

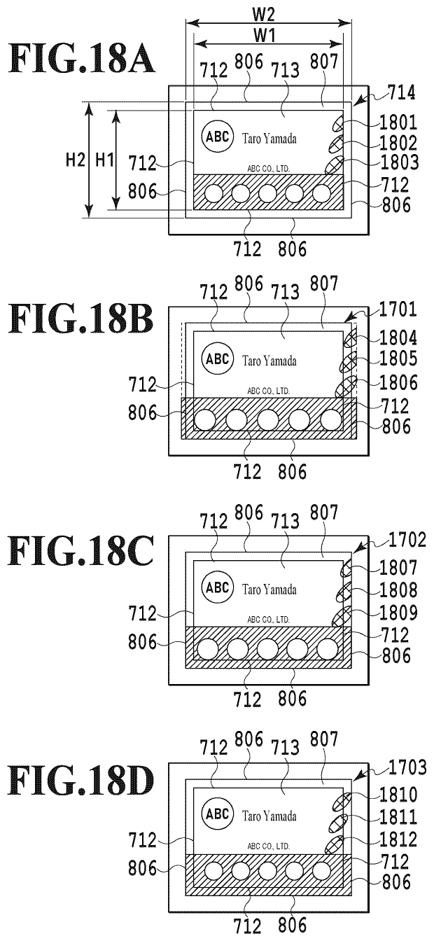

FIGS. 18A to 18D are diagrams describing methods in three ways to change the object including the portion put in contact with the trim line 712 included in the content.

The object before change is changed into the object including the portion put in contact with the bleed line 806. Note that, the object including the portion put in contact with the bleed line 806 may include the portion away from the editing region 713 farther than the bleed line 806.

FIG. 18A illustrates the content including the object including the portion put in contact with the trim line 712. In this case, the object including the portion put in contact with the trim line 712 is the background object 714 and ellipse objects 1801, 1802, and 1803. Since the method of changing the background object 714 into the background objects 1701 to 1703 put in contact with the bleed line 806 is already described, a duplicated description thereof is omitted. Note that, although it is not illustrated, the ellipse object 1801 also includes the portion away from the editing region 713 farther than the trim line 712 in addition to the portion put in contact with the trim line 712. That is, the ellipse object 1801 originally has a complete ellipse shape. In addition, only a portion of the ellipse object 1801 that exists inside the editing region 713 is displayed. A portion of the ellipse object 1801 that protrudes from the editing region 713 also exists actually but is not displayed. The same applies to the ellipse object 1802. The entirety of the ellipse object 1803 is included in the editing region 713.

In a case where the “cut after printing” checkbox 706 is OFF, only the content existing in the editing region 713 is printed. Accordingly, in a case where the “cut after printing” checkbox 706 is OFF, the portion protruding from the editing region 713 is not printed.

Ellipse objects 1804, 1805, and 1806 illustrated in FIG. 18B are obtained by changing according to the background object 1701 and each include the portion away from the editing region 713 farther than the portion put in contact with the bleed line 806 and the bleed line 806. Note that, although it is not illustrated, the ellipse objects 1804 and 1805 each include also the portion protruding from the background object 1701 in addition to the portion overlapping the background object 1701. Additionally, the background object 1701 also includes the portion protruding in right and left directions from the bleed line 806. Accordingly, the ellipse objects 1804 and 1805 also include the portion protruding in the right direction from the bleed line 806. In FIG. 18B, for description, the entirety of the background object 1701 is illustrated, and the portions of the ellipse objects 1804 and 1805 that overlap with the background object 1701 are illustrated.

In a case where the “cut after printing” checkbox 706 is ON, only the content existing in the expanded region 807 is printed. Accordingly, in a case where the “cut after printing” checkbox 706 is OFF, the portion protruding from the expanded region 807 is not printed.

The object 1801 is changed into the object 1804 such that a positional relationship between the editing region 713 (or the background object 714) and each portion of the object 1801 and a positional relationship between the background object 1701 and each portion of the object 1804 become similar to each other. Likewise, the objects 1802 and 1803 are changed into the objects 1805 and 1806, respectively. Accordingly, shapes and positions of the objects 1804, 1805, and 1806 are changed from the objects 1801, 1802, and 1803, respectively.

In a case where the “cut after printing” checkbox 706 is ON, the portions of the objects 1804 to 1806 away from the editing region 713 farther than the bleed line 806 (that is, the portions outside the range of the expanded region 807) may be cut off. Additionally, although in a case of not cutting off the portions, the portions are not printed. The same applies to the background object 1701.

Ellipse objects 1807, 1808, and 1809 illustrated in FIG. 18C are obtained by changing according to the background object 1702 and each include the portion put in contact with the bleed line 806. Note that, although it is not illustrated, the ellipse objects 1807 and 1808 each include also the portion protruding from the background object 1702 in addition to the portion overlapping with the background object 1702. Additionally, unlike the background object 1701, the background object 1702 does not include the portion protruding in the right and left directions from the bleed line 806.

The object 1801 is changed into the object 1807 such that a positional relationship between the editing region 713 (that is, the background object 714) and each portion of the object 1801 and a positional relationship between the background object 1702 and each portion of the object 1807 become similar to each other. Likewise, the objects 1802 and 1803 are changed into the objects 1808 and 1809, respectively.

Since the objects 1807 to 1809 do not include the portions away from the editing region 713 farther than the bleed line 806, the processing of cutting off may not be particularly performed. The same applies to the background object 1702.

An ellipse object 1810 illustrated in FIG. 18D is obtained by adding the bleed portion to the ellipse object 1801. In this case, the bleed portion is a portion that is included in the ellipse object 1810 but not in the ellipse object 1801. It is also possible to say that the bleed portion is a portion included in the region defined by the bleed line 806 (the expanded region 807) but existing in the region not included in the editing region 713.

The ellipse object 1810 illustrated in FIG. 18D is obtained by adding the bleed portion to the ellipse object 1801 illustrated in FIG. 18A. Accordingly, the image content of the portion of the ellipse object 1810 existing in the editing region 713 coincides with the image content of the ellipse object 1801. The image content of the portion (the bleed portion) of the ellipse object 1810 existing outside the editing region 713 may be prepared in advance or may be generated based on the image content of the ellipse object 1801. Likewise, the object 1802 is changed into an object 1811. An object 1812 is the same as the object 1803.

Since the objects 1810 to 1812 do not have the portions away from the editing region 713 farther than the bleed line 806, the processing of cutting off may not be particularly performed. The same applies to the background object 1703.

Note that, also in a case where the background object 714 is changed into the background object 1703, the following method may be applied taking into consideration the identity of the design. That is, instead of the ellipse objects 1810 to 1812, the ellipse objects 1804 to 1806 or the ellipse objects 1807 to 1809 may be combined with the background object 1703.

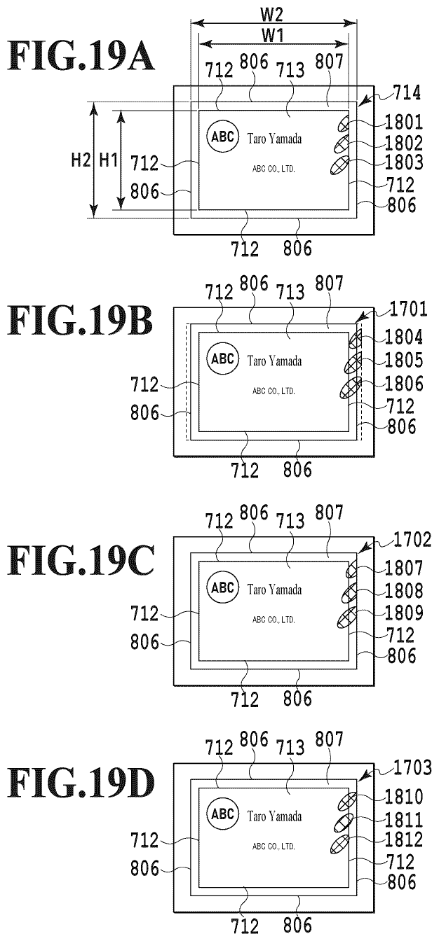

FIGS. 19A to 19D are diagrams describing methods in three ways to change the object including the portion put in contact with the trim line 712 included in the content. The object before change is changed into the object including the portion put in contact with the bleed line 806. Note that, the object including the portion put in contact with the bleed line 806 may further include the portion away from the editing region 713 farther than the bleed line 806.

FIG. 19A illustrates the content including the object including the portion put in contact with the trim line 712. In this case, the object including the portion put in contact with the trim line 712 is the ellipse objects 1801 to 1803.

In an example illustrated in FIGS. 19A to 19D, the content does not include the background object. However, the objects 1801 to 1803 are changed similarly to the case where the content includes the background object. Accordingly, positions of the objects 1804 to 1806 are common between FIGS. 18B and 19B. Positions of the objects 1807 to 1809 are common between FIGS. 18C and 19C. Positions of the objects 1810 to 1812 are common between FIGS. 18D and 19D.

As above, according to the present embodiment, since the bleed processing is automatically applied before proceeding to printing, the user does not need to edit the content taking into consideration the bleed. Additionally, in a case where the printing medium on which the content is printed is cut, it is possible to confirm a state of the bleed on the preview screen before printing, and therefore it is possible to reduce the undo process due to misprinting.

Note that, although the content in the business card size and the content in the A4 size are described as an example of the content printed by the printing apparatus 102 in the present embodiment, the size of the content is not limited thereto. For example, a poster in an A0 size or an A1 size may be the content. Additionally, the size of the content may be the postcard size. The present embodiment is applicable as long as it is a configuration that allows the user to print the content created on the Web application 601 by the printing apparatus 102 using the printing application 502.

### OTHER EMBODIMENTS

A “preview” button may be arranged in the control region 704. In addition, once the user presses the “preview” button, the preview of the content on which the change processing is performed or the change processing is not performed may be displayed according to ON/OFF of the “cut after printing” checkbox 706.

A “print” button may be arranged in the control region 704. In addition, once the user presses the “print” button, without previewing, the content on which the change processing is performed or the change processing is not performed may be printed according to ON/OFF of the “cut after printing” checkbox 706.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve the convenience related to a bleed for a printing content.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-122527, filed Jul. 29, 2024, which is hereby incorporated by reference herein in its entirety.

What is claimed is:

1. A non transitory computer readable storage medium storing a program for causing a computer to perform as:
an editing unit that can edit a printing content including one or more objects in an editing region displaying a trim line corresponding to a cutting position of a printing medium; and
a display control unit that displays a region related to the printing content on a display unit, wherein
in a case where setting of cutting the printing medium on which the printing content is printed at a position of the trim line is set, the display control unit displays a bleed line, which is different from the trim line and corresponds to a position to which printing processing is performed, the position being outside the cutting position, and a preview region displaying the printing content.

2. The storage medium according to claim 1, wherein the program further causes the computer to perform as:
a change unit that performs change processing to change an object including a portion put in contact with the trim line into an object including a portion put in contact with the bleed line, wherein
the display control unit displays the object on which the change processing is performed in the preview region.

3. The storage medium according to claim 2, wherein
the object including the portion put in contact with the trim line further includes a portion away from the editing region farther than the trim line.

4. The storage medium according to claim 2, wherein
the object including the portion put in contact with the bleed line further includes a portion away from the editing region farther than the bleed line.

5. The storage medium according to claim 2, wherein
one of the objects including the portion put in contact with the trim line is a first background object whose existence range is the editing region, and
in the change processing, the change unit changes the first background object into a second background object whose existence range includes a region defined by the bleed line.

6. The storage medium according to claim 5, wherein
the second background object is obtained by enlarging the first background object.

7. The storage medium according to claim 5, wherein
the second background object is obtained by adding a bleed portion to the first background object.

8. The storage medium according to claim 7, wherein
an image content of the bleed portion is prepared in advance correspondingly to the first background object or generated based on an image content of the first background object.

9. The storage medium according to claim 2, wherein
the change unit changes the object as a target of the change processing into an object after the change processing by changing a shape, a position, or both of the object.

10. The storage medium according to claim 2, wherein
for the object as a target of the change processing, the change unit performs the change processing such that a positional relationship between a region defined by the bleed line and each portion of the object after the change processing is similar to a positional relationship between the editing region and each portion of the object before the change processing.

11. The storage medium according to claim 2, wherein
for the object as a target of the change processing, the change unit adds a bleed portion to the object before the change processing.

12. The storage medium according to claim 11, wherein
the bleed portion exists in a region included in a region defined by the bleed line but not included in the editing region.

13. The storage medium according to claim 11, wherein
the bleed portion is prepared in advance for the object as the target of the change processing or generated based on a portion existing before the change processing of the object as the target of the change processing.

14. The storage medium according to claim 2, wherein
cutting the printing medium at the trim line means that the printing medium is cut while using the trim line as a target cutting line, and
the bleed line is a line used as a guide for avoiding generation of a blank space between the object after the change processing and the actual cutting line in a case where the change processing is performed on the object including the portion put in contact with the trim line, even in a case where an error occurs between the target cutting line and the actual cutting line in a case of cutting the printing medium at the trim line.

15. The storage medium according to claim 2, wherein
in a case where setting of not cutting the printing medium on which the printing content is printed at the trim line is set, the display control unit displays the printing content, in which the change processing is performed on no object, in the preview region.

16. The storage medium according to claim 2, wherein the program further causes the computer to perform as:
a unit that causes a printing unit to print the printing content on which the change processing is performed on the printing medium by accepting an input for printing in a case where setting of cutting the printing medium on which the printing content is printed at the trim line is set.

17. The storage medium according to claim 2, further causing the computer to perform as:
a unit that causes a printing unit to print the printing content on which the change processing is not performed on the printing medium by accepting an input for printing in a case where setting of not cutting the printing medium on which the printing content is printed at the trim line is set.

18. The storage medium according to claim 2, wherein the program further causes the computer to perform as:
a unit that causes a cutting unit to cut the printing medium on which the printing content on which the change processing is performed is printed at the trim line in a case where setting of cutting the printing medium on which the printing content is printed at the trim line is set.

19. A printing content editing apparatus comprising:
an editing unit that can edit a printing content including one or more objects in an editing region displaying a trim line corresponding to a cutting position of a printing medium; and
a display control unit that displays a region related to the printing content on a display unit, wherein
in a case where setting of cutting the printing medium on which the printing content is printed at a position of the trim line is set, the display control unit displays a bleed line, which is different from the trim line and corresponds to a position to which printing processing is performed, the position being outside the cutting position, and a preview region displaying the printing content.

20. A printing content editing method comprising:
editing in which a printing content including one or more objects can be edited in an editing region displaying a trim line corresponding to a cutting position of a printing medium; and
display-controlling to display a region related to the printing content on a display unit, wherein
in a case where setting of cutting of the printing medium on which the printing content is printed at a position of the trim line is set, in the display-controlling, a bleed line, which is different from the trim line and corresponds to a position to which printing processing is performed, the position being outside the cutting position, and a preview region displaying the printing content are displayed.
